(19) United States
(12) Patent Application Publication
(10) Pub. No.: US 2021/0061025 A1
(43) Pub. Date: Mar. 4, 2021

(54) TIRE WITH NO BEAD TURNUP

(71) Applicant: The Goodyear Tire & Rubber Company, Akron, OH (US)

(72) Inventors: Gilles Bonnet, Niederfenlen (LU); Gilles Reichling, Vichten (LU); Olivier Di Prizio, Hettange-Grande (FR); Robert Edward Lionetti, Bereldange (LU); Nicolas Soultis, Freylange (BE); Frederic Marie Bernard Marechal, Selange (BE); William Alain Francis Ghislain Talbot, Bastogne (BE); Patrice Jacques Omont, Hobscheid (LU)

(21) Appl. No.: 16/939,671

(22) Filed: Jul. 27, 2020

Related U.S. Application Data
(60) Provisional application No. 62/893,383, filed on Aug. 29, 2019.

(51) Int. Cl. B60C 15/00; B60C 15/05; B60C 15/06

(52) U.S. Cl. CPC B60C 15/0018; B60C 15/0607; B60C 15/05

(57) ABSTRACT

A tire having no ply turnup is described, wherein the tire has a tread, a single layer of ply, a first column bead and a second column bead, wherein the radially inner end of the single layer of ply is secured between the first column bead and the second column bead.

### FIELD OF THE INVENTION

The invention relates generally to tires and more particularly to a pneumatic tire.

### BACKGROUND OF THE INVENTION

For high performance and ultra-high performance tires, it is often desired to eliminate the ply turnup around the bead. Eliminating the ply turnup removes the stress concentration and improves the ply line in the lower area of the tire. Further, if the bead has no ply turnup, there is increased design flexibility for tire/rim interface improvement. However, it is difficult to build the tire without building the tire on a solid core. The ply cord typically pulls out from the bead during the tire curing process, because of the rapid expansion of the tire carcass during the cure process. The solid core eliminates the movement of the carcass. However, building a tire on a solid core requires special equipment and often is a much slower tire building process. Thus, it is desired to provide a tire that has no ply turnup using conventional tire building equipment.

### Definitions

“Aspect ratio” of the tire means the ratio of its section height (SH) to its segment width (SW) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tangent delta”, or “tan delta,” is a ratio of the shear loss modulus, also known as G″, to the shear storage modulus (G′). These properties, namely the G′, G″ and tan delta, characterize the viscoelastic response of a rubber test sample to a tensile deformation at a fixed frequency and temperature, measured at 100° C.

“Tread element” or “traction element” means a rib or a block element defined by a shape with adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a cross-sectional view of a tire with no bead turnup;

FIG. 2 is a close-up view of a bead area of a cured tire with the bead construction of FIG. 1;

FIG. 3 is a schematic of the bead area shown with the inner liner, apex 1 and apex 2; and

FIG. 4A is a first embodiment of a second apex, while FIG. 4B is a second embodiment of a second apex.

### DETAILED DESCRIPTION OF THE PRESENT INVENTION

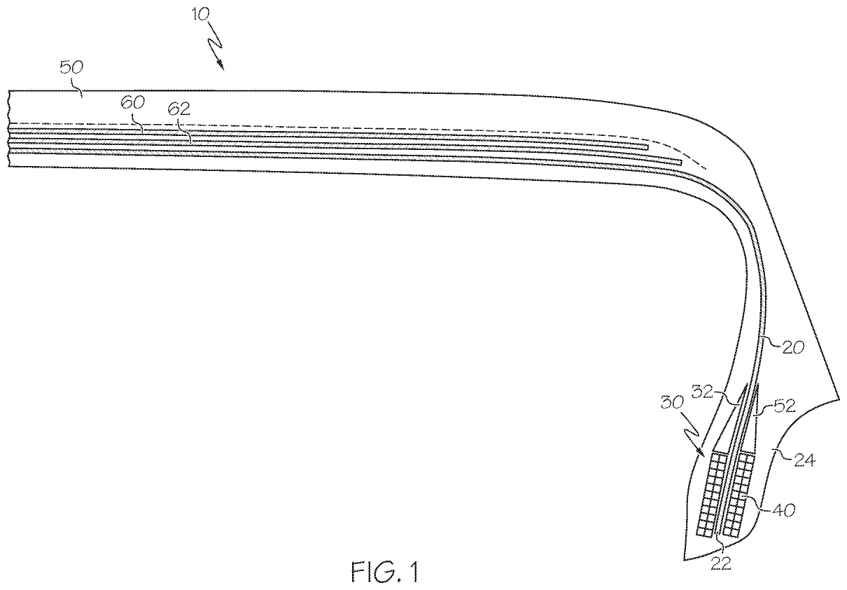

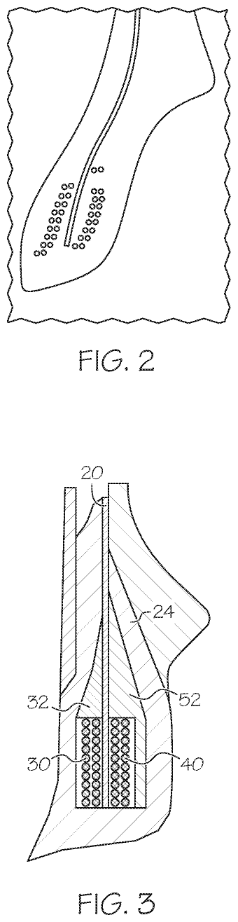

FIG. 1 illustrates a tire 10 of the present invention that has no bead turnup. The tire 10 may further include a tread 50, and belts 60,62. The belts 60,62 may comprise conventional belt configurations known to those skilled in the art.

The tire 10 has a single layer or monolayer of ply 20, that has a radially inner portion 22 that is clamped between a first bead 30 and a second bead 40. Preferably, the tire has no more than one layer of ply 20. The ply layer 20 is comprised of radial cords that may be formed of a high modulus 2200/3 denier cords or 3340/2 denier cords. The cord material may be nylon, aramid, or a hybrid construction of nylon/aramid. The lower ply end 22 is clamped between the first bead 30 and the second bead 40. The first bead 30 is a column bead bundle, preferably a double column bead bundle that may range from a 2 column, with 6 wires column construction to a 2 column with 13 wire column construction. The first bead 30 is formed of metal wire, with a wire diameter in the range of 0.8 to 2 mm, and preferably a wire with a 0.89 mm diameter. The bead wire has a desired tensile strength which preferably ranges from 2100 to 2500 MPA. It is preferred that the minimum percent elongation at break of 6%, tested according to ASTM D4975-14. The first bead 30 may be pre-formed and then applied onto the tire building drum. An optional first apex 32 may be positioned radially outward of the first bead column 30.

The tire further includes a second or axially outer bead 40 that functions to clamp the ply ending 22 between the first and second beads 30,40. The axially outer bead 40 is a double column bead bundle formed of wire. The double column bead bundle that may range from a 2 column, with 6 wires column construction to a 2 column with 13 wire column construction. The second column bead 40 is formed of metal wire, with a wire diameter in the range of 0.8 to 2 mm, and more preferably a wire with a 0.89 mm diameter. The bead wire has a desired tensile strength which preferably ranges from 2100 to 2500 MPA. It is preferred that the minimum percent elongation at break of 6%, tested according to ASTM D4975-14.

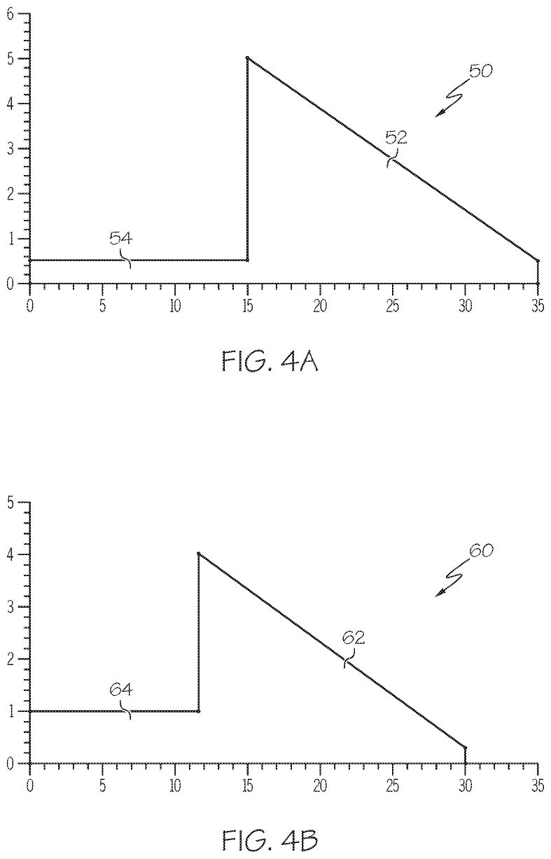

A second apex 50 is located radially outward of the axially outer bead 40. The second apex has a radially outer portion 52 that is triangular, and is located between the ply 20 and the chafer 24. The second apex 50 has a radially inner lip 54 that is positioned adjacent the axially outer bead 40. The second apex 50 is formed from a highly stiff material in order to get a stiffness gradient between the bead wire and the chafer compound. The second apex is mechanically locked to the second bead and the surrounding area, minimizing or eliminating the ply slippage during the tire building process and shaping process. A first embodiment of a second apex 50 is shown in FIG. 3 and FIG. 4A. The upper triangular portion 52 width is adapted to the width of the second bead. The narrow lip portion 54 width ranges from 0.5 mm to 1 mm. FIG. 4B illustrates a second embodiment of the second apex 60, that has a reduced radial height, and a wider lip.

The stiffness may be characterized by the dynamic modulus G′, which are sometimes referred to as the “shear storage modulus” or “dynamic modulus,” reference may be made to Science and Technology of Rubber, second edition, 1994, Academic Press, San Diego, Calif., edited by James E. Mark et al, pages 249-254. The shear storage modulus (G′) values are indicative of rubber compound stiffness which can relate to tire performance. The tan delta value at 100° C. is considered as being indicative of hysteresis, or heat loss.

In a first embodiment, the second apex 50 comprises a stiff rubber composition having a shear storage modulus G′ measured at 1% strain and 100° C. according to ASTM D5289 ranging from 14 to 43 MPa, In a more preferred embodiment, the second apex 50 comprises a rubber composition having a shear storage modulus G′ measured at 1% strain and 100° C. according to ASTM D5289 ranging from 23 to 43 MPa.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire having no ply turnup, the tire comprising a tread, a single layer of ply, a first column bead and a second column bead, wherein the radially inner end of the single layer of ply is secured between the first column bead and the second column bead.

2. The tire of claim 1 wherein the first column bead has a two column wire construction with each column having 6 or more wires.

3. The tire of claim 1 wherein the second column bead has a two column wire construction with each column having 6 or more wires.

4. The tire of claim 1 further including a first triangular shaped apex located radially outward of the first column bead.

5. The tire of claim 1 further comprising a second apex, having a first triangular shaped portion located radially outward of the second column bead.

6. The tire of claim 5 wherein the second apex has a first portion comprising a lip, wherein the axial width of the lip is less than the axial width of the first triangular shaped portion.

7. The tire of claim 6 wherein the lip is positioned against the second column bead.
